(19) United States
(12) Patent Application Publication
(10) Pub. No.: US 2026/0045052 A1
(43) Pub. Date: Feb. 12, 2026

(54) Computer-Based Modification of Visualizations in a Virtual World Collaboration Environment

(71) Applicant: INTERNATIONAL BUSINESS MACHINES CORPORATION, ARMONK, NY (US)

(72) Inventors: Scott E. SCHNEIDER, Rolesville, NC (US); Sarbajit Kumar RAKSHIT, Kolkata (IN); Carolina GARCIA DELGADO, Zapopan (MX); Tushar AGRAWAL, West Fargo, ND (US)

(21) Appl. No.: 18/734,398

(22) Filed: Jun. 5, 2024

(51) Int. Cl. G06T 19/20; G06F 3/01; G06N 3/0475; G06T 19/00

(52) U.S. Cl. CPC G06T 19/20; G06F 3/011; G06N 3/0475; G06T 19/006; G06T 2219/024; G06T 2219/2021

(57) ABSTRACT

In an approach to improve computer-based virtual world collaboration environments, embodiments of the present invention embodiments identify a context associated with a current state of a virtual environment and determines a physical object that is being rendered as a virtual display in the virtual environment based on the context. Further, embodiments render a virtual object representing the physical object according to the context using a generative model in a such a manner that the virtual object is rendered visually distinct from the physical object being represented.

### BACKGROUND OF THE INVENTION

The present invention relates generally to virtual world environments, and more particularly to the field of computer-based virtual world collaboration.

A virtual world (also referred to as a virtual space) is a computer-simulated environment which may be populated by many users who can create a personal avatar, and simultaneously and independently explore the virtual world, participate in its activities, and communicate with others. It is a concept that merges virtual reality (VR), augmented reality (AR), and other immersive technologies to create a digital environment where users can communicate, collaborate, and engage with each other and digital objects. Virtual worlds are closely related to mirror worlds. In a virtual world, the user accesses a computer-simulated world which presents perceptual stimuli to the user, who in turn can manipulate elements of the modelled world and thus experience a degree of presence.

Virtual collaboration is the method of collaboration between two or more users that is carried out via technology-mediated communication. Virtual collaboration follows the same process as collaboration, but the parties involved in virtual collaboration do not physically interact (in the traditional sense) and communicate exclusively through technological channels. Distributed teams use virtual collaboration to simulate the information transfer present in face-to-face meetings, communicating virtually through verbal, visual, written, and digital means. Virtual collaboration is commonly used by globally distributed business and scientific teams. Ideally, virtual collaboration is most effective when it can simulate face-to-face interaction between team members through the transfer of contextual information, but technological limits in sharing certain types of information prevent virtual collaboration from being as effective as face-to-face interaction.

### SUMMARY

Embodiments disclose a computer-implemented method, a computer program product, and a system, for improving computer-based virtual world collaboration environments, the computer-implemented method comprising: identifying a context associated with a current state of a virtual environment, determining a physical object that is being rendered as a virtual display in the virtual environment based on the context, and rendering a virtual object representing the physical object according to the context using a generative model, wherein the virtual object is rendered visually distinct from the physical object being represented.

Embodiments further disclose identifying modifications to be applied to the virtual display representing the physical object within the virtual environment based on the context of the virtual environment, executing the modifications, through a three-dimensional generative adversarial network, to the virtual display representing the physical object within the virtual environment based on the context of the virtual environment, wherein the virtual environment is a virtual world collaborative environment, identifying defects in the physical object and a predetermined area of a physical space, and applying a selection criterion to determine that the physical object should be shown in the virtual environment based on a metadata analysis and contextual considerations. Embodiments additionally disclose responsive to identifying the physical object from a physical environment is going to be displayed within the context of the virtual environment, retrieving predetermined commands that instruct a virtual environment construction engine to modify the visual of the physical object in accordance with one or more requirements of one or more predetermined policies and the context of the virtual environment, identifying metadata by analyzing data associated with a predetermined area in a physical space and the context of the virtual environment; associating the metadata to the physical object in the predetermined area in the physical space; and identifying one or more adaptations to be made to a visual appearance of the virtual rendering of the physical objects in the virtual environment based on the metadata and the context of virtual environment. Embodiments additionally disclose assigning one or more unique identifiers or tags to the physical object to establish a link between the physical object and the associated metadata, and analyzing factors associated with the context of the virtual environment, wherein the factors comprise: a purpose the virtual environment, participants of the virtual environment, location associated with the virtual environment, specific requirements associated with the virtual environment, visual coherence, relevance of the physical object and an identified defect, and a desired collaborative experience.

### BRIEF DESCRIPTION OF THE DRAWINGS

FIG. 1 is a functional block diagram illustrating a distributed data processing environment, executing a virtual world collaboration environment program, in accordance with an embodiment of the present invention;

FIG. 2 illustrates a functional block diagram and operational steps of the virtual world collaboration environment program, on a server computer within the distributed data processing environment of FIGS. 1, in accordance with an embodiment of the present invention; and

FIG. 3 illustrates operational steps of the virtual world collaboration environment program, on a server computer within the distributed data processing environment of FIGS. 1, in accordance with an embodiment of the present invention.

### DETAILED DESCRIPTION

Embodiments recognize that during interactions within a virtual world collaborative environment, users are typically located in a physical setting where various types of physical objects exist. To maintain context within the virtual world environment, these physical objects may also need to be represented visually. However, it is possible that these physical objects may have visual defects (broken, stain, fractures, discoloration, asymmetric shape, and/or any other visual defect known and understood in the art). Consequently, displaying these physical objects as they are in the virtual world can cause visual discomfort. To address this issue, embodiments there is a need for a method and system that can visually correct these physical objects when they are depicted within the virtual world collaborative environment.

Embodiments improve the current art of virtual world collaboration by improving the efficiency of virtual world collaboration by selectively render physical objects into a virtual environment. Additionally, embodiments improve the art and solve at least the one or more issues stated above by selectively render physical objects into a virtual environment. Embodiments may selectively render physical objects into a virtual environment by (i) identifying a predefined policy associated with a current state of the virtual environment; (ii) determining a physical object that is being rendered as a virtual display in the virtual environment based on the predefined policy; (iii) rendering a virtual object representing the physical object according to the policy using a generative AI model, wherein the virtual object is rendered visually distinct from the physical object it represents (iv) identifying corrections to be applied to the virtual display representing a physical object within the virtual environment based on one or more predefined policies of the virtual environment; (v) executing corrections, through a three-dimensional generative adversarial network, to the virtual display representing a physical object within a virtual environment based on predetermined context of a virtual world collaborative environment; and/or (vi) responsive to identifying a physical object from the physical world is going to be displayed within the context of the virtual world collaboration, retrieving predetermined commands that instruct the virtual world environment construction engine modify the visual correction of that physical object in accordance with the requirements of the virtual world collaboration.

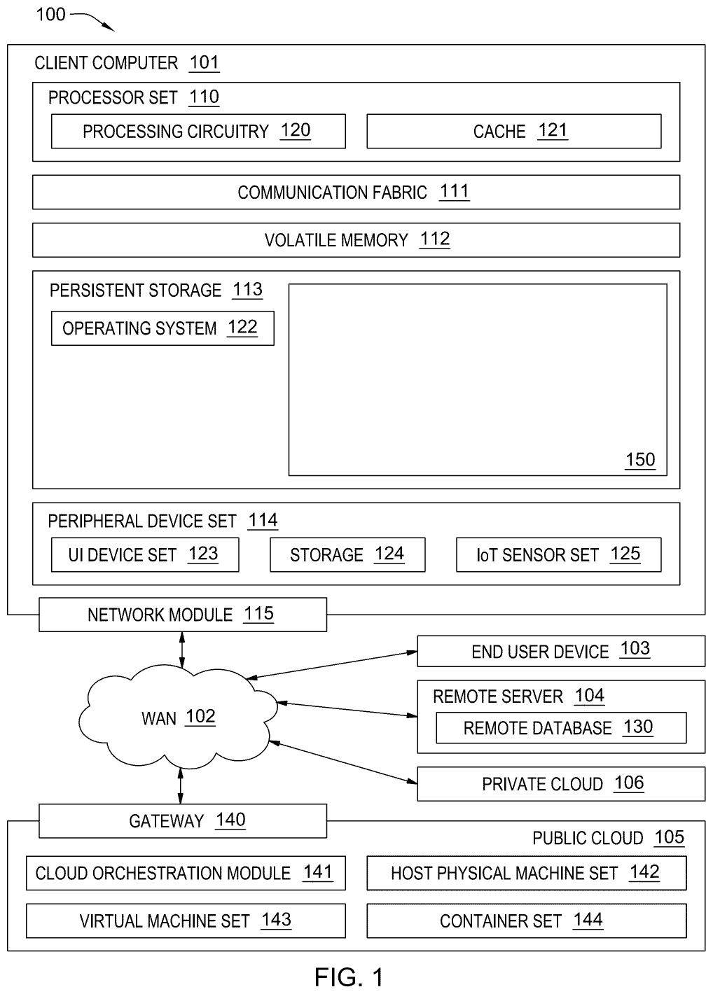

Implementation of embodiments of the invention may take a variety of forms, and exemplary implementation details are discussed subsequently with reference to the Figures (i.e., FIG. 1-FIG. 3).

It should be noted herein that in the described embodiments, participating parties have consented to being recorded and monitored, and participating parties are aware of the potential that such recording and monitoring may be taking place. In various embodiments, for example, when downloading or operating an embodiment of the present invention, the embodiment of the invention presents a terms and conditions prompt enabling the user to opt-in or opt-out of participation. Similarly, in various embodiments, emails, and texts, and/or responsive display prompts begin with a written notification that the user's information may be recorded or monitored and may be saved, for the purpose of consolidating shipments to reduce carbon emissions and shipping costs. These embodiments may also include periodic reminders of such recording and monitoring throughout the course of any such use. Certain embodiments may also include regular (e.g., daily, weekly, monthly) reminders to the participating parties that they have consented to being recorded and monitored for collision avoidance and autonomous vehicle safety measures and may provide the participating parties with the opportunity to opt-out of such recording and monitoring if desired.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

Computing environment 100 contains an example of an environment for the execution of at least some of the computer code involved in performing the inventive methods, such as virtual world collaboration environment program (component) 150. In addition to component 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and component 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in component 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in component 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector. IoT sensor set 125 may be any combination of proximity sensors, image sensor, motion sensor, thermistor, capacity sensing, photoelectric sensor, infrared sensor, level sensor, humidity sensor, pressure sensor, temperature sensor, and/or any sensor and/or IoT sensor known and understood in the art.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, central processing unit (CPU) power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In various embodiments, each participating user has the option to select a preferred virtual world collaboration environment based on predetermined and/or customized choices. Component 150 may facilitate, manage, and/or execute the preferred virtual world collaboration environment and the predetermined and/or customized choices.

Component 150 may selectively render physical objects in a virtual world collaborative environment, based on the context of a virtual world collaboration. Component 150 may perform, via IoT sensor set 125 and/or image capturing systems, context based visual corrections and apply adaptations to physical objects based on predefined policies and metadata of a virtual world collaboration. Component 150 may utilize three-dimensional (3D) generative adversarial networks (GANs) to rectify the visual appearance of physical objects captured within a predefined area while incorporating user-specified corrections, adaptations, and metadata associations. Component 150 may mitigate confusion by enabling participants to view the actual states of the physical objects to distinguish between the physical and corrected surroundings. For example, creating two different virtual visualizations of the physical object, wherein the first virtual visualization is an exact virtual replication of the physical object including the identified defects and the second virtual visualization is a virtual representation of the physical object without the defects, and wherein the first virtual visualization is displayed only to a first user and the second visualization is displayed to one or more second users. Component 150 may render a virtual representation (i.e., virtual visualization) in a virtual world collaboration environment that is visually distinct from the corresponding physical counterpart that the visualization is based on. In various embodiments, users specify modifications, aligning with policies for visual corrections and ensuring accurate representation within the virtual world collaborative setting. The policies of visual adaptation can be stored in cloud hosted server. In various embodiments, component 150 retrieves specific modifications and policies from a knowledge corpus.

In various embodiments, while participating in a virtual world collaborative environment, if a physical object from the physical world is identified as being displayed within the context of the virtual world collaboration, then component 150 receives instruction, based on user preferences and/or policies of the virtual world platform or collaboration, on whether the virtual world environment construction engine should modify the virtual representation of the physical object by visual correcting identified defects in the physical object in accordance with the requirements of the virtual world collaboration. In various embodiments, component 150 generates a list of identified defects (e.g., potential modifications) and outputs a list to the user to selectively choose which modifications to apply to the visualization. In various embodiments, responsive to receiving user feedback (e.g., haptic feedback and/or user selection) component 150 applies the selected and instructed modifications. In various embodiments, based on the received instructions, component 150, via 3D GANs, performs modifications (e.g., visual corrections) to a virtual visualization (i.e., visualization) representing the physical object within the virtual world collaborative environment.

In various embodiments, based on the predefined policy of virtual world collaboration, component 150 identifies the necessary corrections to be applied to the visual appearance of the physical object in the virtual world collaborative environment (e.g., a client meeting where a broken chair should not be shown but the physical boardroom should be displayed). Subsequently, in various embodiments, component 150 utilizes a 3D GAN to modify the visual appearance of the physical objects within the virtual world collaborative environment so that the defects are not visually rendered in the virtual display within the virtual world collaborative environment. For example, a broken chair, a crack in the wall, and a lamp with a missing lamp shade are identified as defects, wherein the 3D GAN is utilized to virtually render the chair as unbroken, the wall without a crack, and the lamp with the lamp in the virtual world collaborative environment. In various embodiments, component 150 may utilize a 3D GAN and a knowledge repository and/or execute an online search to identify reference data on how to render a physical object without an identified defect.

In various embodiments, various types of metadata can be associated with different physical objects in any physical surrounding. Based on the metadata types and the context of virtual world collaboration, component 150 identifies one or more adaptations to be made to the visual appearance of the physical objects in the virtual world collaborative environment. For example, a broken chair is corrected when the chair is shown during a client meeting, however, if the broken chair is to be shown to agencies who will be repairing the chair, then the broken chair will be shown as is (e.g., with the identified defect(s)).

In various embodiments, if a first participant is present in a first physical surrounding area where one or more physical objects are present and the one or more physical objects are modified (e.g., corrected, repaired, and/or repositioned) then component 150 displays a first visualization of the first physical surrounding area and unmodified (i.e., original) visualizations of the one or more physical objects to the first user and a second visualization of the first physical surrounding area and modified visualizations of the one or more physical objects to one or more second participants.

For example, a user invites a friend to his virtualized home within a virtual world to walk his friend through the house to enable the friend to see how the home is constructed and the interior is layout so the friend can visualize they want to decorate the interior of the home. However, in this example, there are a plurality of defects such as scuffed hardwood, peeling wallpaper, broken lamp, crack in the wall and ceiling, discolored paint, a hole in the wall, laundry on the sofa, and/or any other defects in an area that are known and understood in the art that the user does not want the friend to see because they are not relevant to the context of the virtual world collaborative environment (e.g., home interior decorating). Here, component 150 identifies the defects based on the context of the virtual meeting and utilizes a GAN to modify the virtual rendering of the home of the user so that the hardwood is displayed scuff free, the wallpaper is not peeling, the lamp is not broke, there is no crack in the wall and ceiling, the pains is not discolored, there is no hole in the wall, and that there is no laundry on the sofa. Component 150 may utilize historic data and/or metadata from a knowledge corpus or database to identify how to modify the virtual rendering (i.e., visualization) of a physical space and/or physical objects within a visual space based on an identified context of the virtual collaboration environment. Continuing this example, if the user is meeting with a contractor in the virtual environment to receive an estimate for repairs to the home of the user then component 150 will identify defects in the home, based on the context of the virtual collaboration, and modify the visualization of the home so that broken lamp and laundry on the sofa are not displayed in the virtual world but allow the contractor to see the scuffed hardwood, the peeling wallpaper, the crack in the wall and ceiling, the discolored paint, and the hole in the wall.

In various embodiments, component 150 improves the current art of virtual world collaboration by improving the efficiency of virtual world collaboration by selectively render physical objects into a virtual environment. Additionally, embodiments improve the art and solve at least the one or more issues stated above by selectively render physical objects into a virtual environment. In various embodiments, component 150 may selectively render physical objects into a virtual environment by (i) identifying a predefined policy associated with a current state of the virtual environment; (ii) determining a physical object that is being rendered as a virtual display in the virtual environment based on the predefined policy; (iii) rendering a virtual object representing the physical object according to the policy using a generative AI model, wherein the virtual object is rendered visually distinct from the physical object it represents (iv) identifying corrections to be applied to the virtual display representing a physical object within the virtual environment based on one or more predefined policies of the virtual environment; (v) executing corrections, through a three-dimensional generative adversarial network, to the virtual display representing a physical object within a virtual environment based on predetermined context of a virtual world collaborative environment; and/or (vi) responsive to identifying a physical object from the physical world is going to be displayed within the context of the virtual world collaboration, retrieving predetermined commands that instruct the virtual world environment construction engine modify the visual correction of that physical object in accordance with the requirements of the virtual world collaboration.

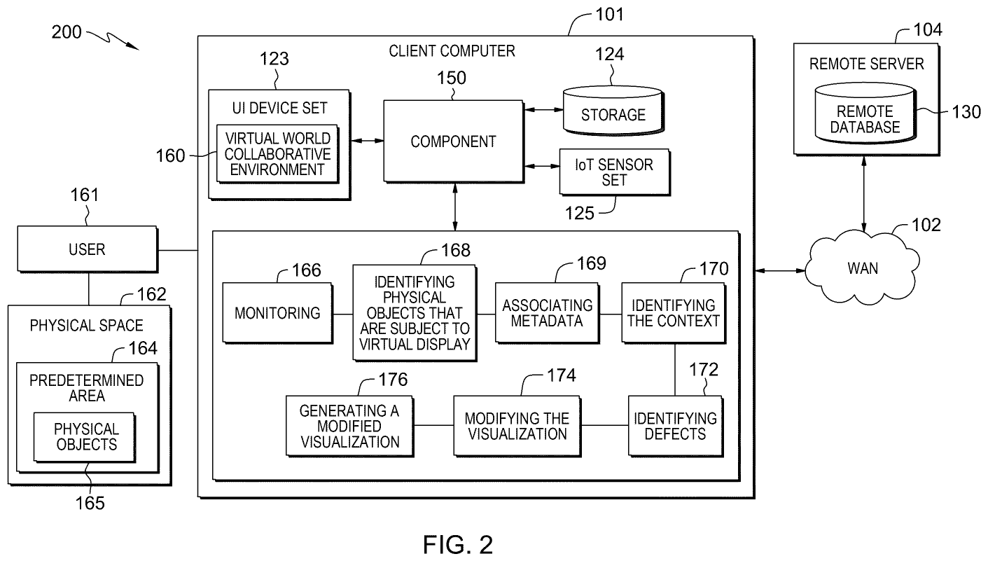

FIG. 2 is a functional block diagram illustrating a distributed data processing environment, generally designated 200, in accordance with one embodiment of the present invention. The term “distributed” as used in this specification describes a computer system that includes multiple, physically distinct devices that operate together as a single computer system. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims. Distributed data processing environment 100 includes client computer 101, and remote server 104 interconnected via WAN 102.

In the depicted embodiment, environment 200 comprises client computer 101, user 161, physical space 162 and remote server 104 interconnected by WAN 102. In various embodiments, via UI device set 123, component 150 issues and/or receives permission from user 161 to track and/or monitor physical space 162 and client computer 101, wherein an opt-in response grants permission for component 150 to access and monitor sensors associated with monitoring and/or generating virtual world collaborative environment 160.

In the depicted embodiment, component 150 monitors 166, via IoT sensor set 125, physical space 162 for physical objects 165. In various embodiments, component 150 may generate a dynamic mapping of physical space 162 and physical objects 165 that continually updates based on the addition or removal of physical objects 165 in physical space 162. Component 150 may store the monitoring 166 of physical space and physical objects 165 as a layout to storage 124 and/or remote database 130. In various embodiments, component 150 may receive and/or retrieve restrictions on physical space 162 from user 161 and/or storage 124 or remote database 130 that limits physical space 162 to predetermined area 164. In various embodiments, component 150 creates and stores multiple layouts of physical space 162.

In the depicted embodiment, component 150 identifies physical objects 165 that are subject to virtual display (i.e., visualization) 168. In various embodiments, component 150 identifies physical objects 165 that are subject to virtual display (i.e., visualization) 168 via IoT sensor set 125 and/or received and/or retrieved user preferences.

In various embodiment, component 150 identifies physical objects 165 within predetermined area 164, wherein identifying physical objects 165 within predetermined area comprises component 150 utilizing a map of physical space 162 and utilizing real-time video feed, via IoT sensor set 125, and previously collected video and image captures to determine the dimensions and identify objects 165 within predetermined area 164 of physical space 162.

In various embodiments, while attending or participating in a virtual world collaborative environment 160, component 150 enables user 161 to onboard physical objects 165 from predetermined area 164. In the depicted embodiment, component 150 comprises UI device set 123 that enables user 161 to communicate with component 150 via client computer 101 (e.g., a virtual reality (VR) headset). In various embodiments, component 150 comprises a user interface (e.g., UI device set 123) in a virtual environment to visualize physical objects 165, wherein component 150 selectively onboards physical objects 165 into a virtual world collaborative environment 160. Onboarding may comprise scanning physical object 165, generating and displaying a virtual representation of physical object 165 into virtual world collaboration environment 160. In various embodiments, component 150, via a VR system, displays the boundary of the physical objects 165 within predetermined area 164 which enables user 161 to select which of the physical objects in predetermined area 164 can be onboarded (i.e., visualized) in the virtual world collaborative environment 160.

In various embodiments, component 150 enables user 161 to select a physical boundary within physical space 162 (e.g., establish predetermined area 164), wherein component 150 onboards physical objects 165 within the selected physical boundary into the virtual world collaborative environment 160 using extrapolated filter lines. For example, two or more visualizations may overlap and the extrapolated filter lines enable a user to identify the physical object and/or cycle through filters based on the context of the virtual world collaboration environment. In various embodiments, if component 150 generates one or more visualizations of a physical object, then component 150 labels each visualization based on the context of the virtual world collaboration environment and automatically cycles through the filters based on the identified context of the virtual world collaboration environment that the user is participating in. Cycling through filters may mean applying generated filters for a virtual world environment to alter what is being displayed to a user. In various embodiments, the extrapolated filter lines are visually super imposed onto the visualization of the physical object so that only a first/primary user can identify where and/or how the visualization was modified. A first/primary user is a user who owns or manages the physical object being visualized into virtual world collaboration environment and/or is hosting the virtual world collaboration environment.

In various embodiments, component 150, via client computer 101 and a VR system, scans the selected physical objects 165 or predetermined area 164 and utilizes the scan to create a 3D virtual world model rendering of predetermined area 164 of physical space 162, and enable participants to interact with and perceive physical objects 165 and predetermined area 164 virtually. In various embodiments, component 150, via client computer 101, identifies physical objects 165 through the utilization of, but not limited to, IoT sensor set 125, other various sensors, cameras, detection mechanisms, and predefined input associated with physical objects 165.

In the depicted embodiment, component 150 identifies physical objects 165 that are subject to virtual display (visualization) 168. In various embodiments, component 150, via sensor set 125 (e.g., LiDAR, Depth sensors, image capturing, motion capturing sensors, etc.), identifies physical objects 165 in predetermined area 164 of physical space 162. In some embodiments, component 150 identifies physical objects 165 through input devices.

In the depicted embodiment, component 150 associates metadata 169 with physical objects 165 in predetermined area 164 of physical space 162, wherein the type of metadata is various, and wherein component 150 analyzes the associated metadata with each physical object 165 to determine the relevance of each physical object 165 and whether a physical object 165 is suitable for display in the virtual world collaborative environment 160. Physical object 165 is suitable for display (i.e., visualization) if the metadata matches the identified context 170, wherein a match is satisfied if a predetermined value or threshold is met or exceeded. The various types of metadata comprise, but are not limited to, attributes such as object type, condition, importance to the type of virtual world collaboration and/or context of the virtual world collaboration, and/or user-defined preferences.

In various embodiments, component 150 receives, retrieves, and/or generates the definition of the types of metadata that are relevant and useful for describing identified physical objects 165. This can comprise attributes such as object type, dimensions, materials, location, ownership, or any other pertinent information, or any other physical, behavioral or chemical parameters of physical objects 165. Component 150 may collect data associated with each physical object 165 within predetermined area 164 to populate associating metadata. The collection may be done through manual entry, automated scanning and image recognition systems, and/or integration with existing databases or systems. In various embodiments, physical objects 165 comprise an IoT enabled system that is utilized as a position identifier and object recognition and metadata generator.

In various embodiments, component 150 assigns one or more unique identifiers or tags to physical objects 165 to establish a link between physical objects 165 and its associated metadata. Component 150 may associate the collected metadata with the corresponding physical objects 165 using the assigned identifiers or tags by linking the metadata to the unique identifiers in a structured format or storing the metadata in remote server 104. In various embodiments, component 150 stores associated metadata 169 in a structured database or metadata repository for easy retrieval and access, which provides efficient organization and management of the metadata associated with the physical objects 165 (i.e., associated metadata). In various embodiments, the metadata of physical object 165 can be, but is not limited to, the types of objects, if the same cause create any risky situation, safe distance from the object, shape, weight, and/or any other metadata known and understood in the art.

In the depicted embodiment, component 150 identifies the context 170 of virtual world collaboration environment 160. Component 150 may take into account the context of the virtual world collaboration environment 160 (e.g., the purpose, the participants, the location, and specific requirements associated with the virtual world collaboration) and may consider factors such as, but not limited to, visual coherence, relevance, and the desired collaborative experience. In various embodiments, component 150 analyzes the data and associated metadata 169 (e.g., metadata associated with physical objects 165 and/or virtual world collaborative environment 160) to identify the context 170 of the of the virtual collaboration. Component 150 may identify the purpose of any virtual world collaborative environment 160. In various embodiments, component 150 analyzes virtual world collaborative environment 160 collect and identify the characteristics of virtual world collaborative environment 160, wherein the analysis comprises examining the virtual environment, the presence of avatars or virtual objects, and the activities taking place within the environment. The characters may comprise, but are not limited to features, subject/topic of virtual world collaborative environment 160, time of day, participants, host system, interactions, and agenda of the interactions.

In various embodiments, component 150 analyzes the interactions and behaviors of the users within the virtual world collaborative environment 160, wherein the analyzing of the interactions comprises, but is not limited to, studying user movements, communication patterns, and engagement with virtual objects or other participants. In various embodiments, component 150 searches and identifies cues or indicators within virtual world collaborative environment 160 that provide context clues. The cues may comprise visual elements, audio cues, textual information, and/or any other contextual information embedded in the environment. Component 150 may utilize machine learning and artificial intelligence techniques to analyze and process the gathered data, which may comprise applying natural language processing, computer vision, and/or data mining algorithms to identify patterns, correlations, and context-related information.

In the depicted embodiment, component 150 identifies defects 172 in physical objects 165 and/or predetermined area 164 of physical space 162. In various embodiments, based on the metadata analysis and contextual considerations, component 150 applies selection criteria to determine which physical objects should be shown in the virtual world collaborative environment 160. The criteria may include, but is not limited to, object importance, visual aesthetics, functional relevance, or user-defined preferences. In some embodiments, the criteria is predetermined. Component 150 may identify the contextual relevancy of physical objects 165 in relation to virtual collaboration environment 160. In various embodiments, component 150 identifies the contextual relevancy of physical object 165 to be displayed as a digital object in virtual world collaborative environment 160, along with the quality of physical object 165 (i.e., identifying defects in physical objects 165). In various embodiments, component 150 receives and/or retrieves a predefined context and purpose of virtual world collaborative environment 160. Component 150 may Identify the goals, activities, and theme of virtual world collaborative environment 160 to establish the criteria for physical object 165 selection and identify defects in physical objects 165.

In various embodiments, component 150 performs object relevance and quality assessment to determine if physical object 165 is relevant to the context of virtual world collaboration environment 160. In various embodiments, if component 150 determines that physical object 165 is relevant to the context of virtual world collaboration environment 160 then component 150 will create a virtual representation of physical object 165 within collaboration environment 160. In various embodiments, if component 150 determines that physical object 165 is not relevant to the context of virtual world collaboration environment 160 then component 150 will omit the visualization of physical object 165 from virtual world collaboration environment 160. In various embodiments, if component 150 determines that physical object 165 is relevant to the context of virtual world collaboration environment 160 then component 150 will identify any defects in physical objects 165 prior to generating a visualization of physical object 165 in virtual world collaboration environment 160.

In various embodiments, component 150 will consider how physical objects 165 aligns with the context, theme, and activities of virtual world collaborative environment 160 and determine if physical objects 165 contributes to the overall experience, enhances collaboration, or supports specific tasks or interactions, and considers the policy (i.e., protocol) of visual creation in virtual world collaborative environment 160. Component 150 may utilize predefined parameters to map or match the parameters based on similarities or differences of the parameters and physical objects 165 and/or defects associated with physical objects 165 and utilizes one or more predefined protocols to identify what which physical object 165 can be visualized and which physical object 165 can be modified. In various embodiments, while creating a visualization (e.g., 3D virtual representation) of physical object 165, component 150 identifies a predetermined quality level for a virtualized physical object 165 in virtual world collaboration environment 160, wherein the quality is evaluated based on predefined characteristics, such as, but not limited to, dirty, broken, damaged, dislocated, stained, fractures, discoloration, asymmetric shape, and/or any other visual defect and guidelines known and understood in the art.

In the depicted embodiment, component 150 modifies the visualization 174 of physical object 165 based on the identified defects. In various embodiments, component 150 modifies, via a GAN, the visualization of physical objects 165 in the virtual world collaborative environment 160. In various embodiments, based on the context of virtual world collaboration environment 160, component 150 validates the current state of physical object 165 and the deviation from the predetermined quality level for a virtualized physical object 165. In various embodiments, based on the validation and deviation of quality, component 150 applies a GAN to correct the quality of the physical object in the virtual world collaborative environment 160 by modifying the visualization of physical object 165 until a predetermined threshold is met and/or predetermined guidelines or policies are met. In various embodiments, component 150 utilizes a GAN to identify defects in physical objects 165 and/or predetermined area 164, wherein component 150 utilizes the GAN to modify the visualization of physical objects 165 and/or physical space 162 in predetermined area 164 to match the identified context of virtual world collaboration environment, meet a predetermined threshold, and/or satisfy a predetermined policy.

In various embodiments, component 150 trains a GAN using a predetermined dataset. GANs may consist of a generator network that generates synthetic virtual representations of one or more physical objects (e.g., walls, ceiling, floors, chairs, tables, lamps, windows, televisions, and/or any other physical object known and understood in the art). Component 150 may generate and attach one or more classifiers that distinguish between different visualized versions of a single physical object and associate a unique identifier based on the context and modification for each generated visualization.

In the depicted embodiment, component 150 generates a modified visualization 176 of physical objects 165 and/or physical space 162. In various embodiments, component 150 generates a modified visualization 176 of physical objects 165 and/or physical space 162 in virtual world collaboration environment 160. In various embodiments, component 150 outputs, via client computer 101, the modified visualization 176 of physical objects 165 and/or physical space 162 in virtual world collaboration environment 160.

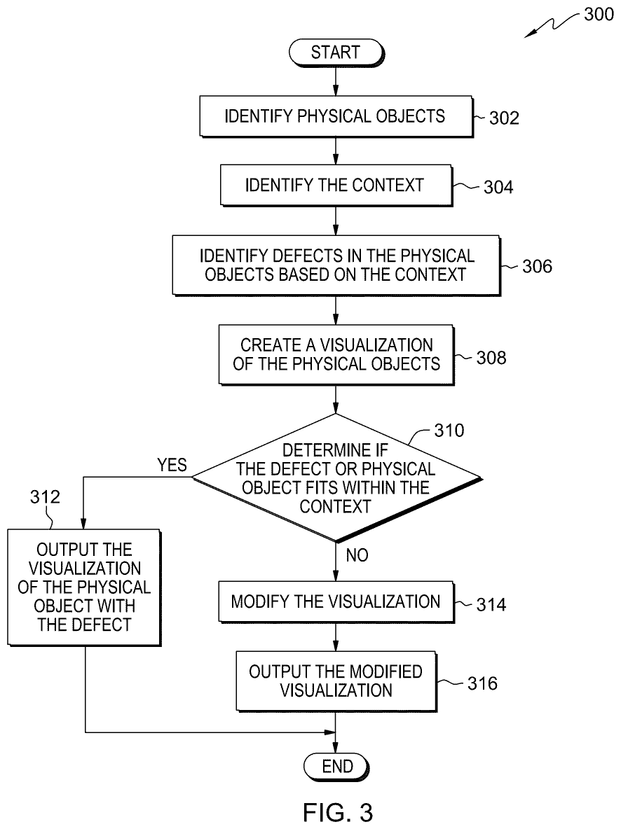

FIG. 3 illustrates operational steps of component 150, generally designated 300, in communication with client computer 101, remote server 104, private cloud 106, EUD 103, client computer 101, and/or public cloud 105, within distributed data processing environment 100, for selectively rendering physical objects into a virtual environment, the computer-implemented method, in accordance with an embodiment of the present invention. FIG. 3 provides an illustration of one implementation and does not imply any limitations with regard to the environments in which different embodiments may be implemented. Many modifications to the depicted environment may be made by those skilled in the art without departing from the scope of the invention as recited by the claims.

In block 302, component 150 identifies physical object in a predetermined area of a physical space. In various embodiments, component 150 identifies physical objects that are subject to virtual display (i.e., visualization) via IoT sensor set and/or received and/or retrieved user preferences. In various embodiments, while attending or participating in a virtual world collaborative environment, component 150 enables user to onboard physical objects from predetermined area. In the depicted embodiment, component 150 comprises a user interface that enables a user to communicate with component 150 via a virtual reality (VR) headset. In various embodiments, component 150 comprises a user interface (e.g., UI device set 123) in a virtual environment to visualize the one or more physical objects, wherein component 150 selectively onboards the one or more physical objects into a virtual world collaborative environment. In various embodiments, component 150, via a VR system, displays the boundary of the one or more physical objects within a predetermined area which enables a user to select which of the physical objects in the predetermined area can be onboarded (i.e., visualized) in the virtual world collaborative environment.

In various embodiments, component 150 identifies the one or more physical objects through the utilization of, but not limited to, and IoT sensor set, other various sensors, cameras, detection mechanisms, and predefined input associated with the one or more physical objects. In the depicted embodiment, component 150 identifies the one or more physical objects that are subject to virtual display. In various embodiments, component 150, via a sensor set (e.g., LiDAR, Depth sensors, image capturing, motion capturing sensors, etc.), identifies the one or more physical objects in the predetermined area of the physical space. In some embodiments, component 150 identifies the one or more physical objects through input devices.

In block 304, component 150 identifies the context of a virtual world collaboration environment. In various embodiments, component 150 identifies the context of the virtual world collaboration environment. Component 150 may take into account the context of the virtual world collaboration (e.g., the purpose, the participants, the location, and specific requirements associated with the virtual world collaboration) and may consider factors such as, but not limited to, visual coherence, relevance, and the desired collaborative experience. In various embodiments, component 150 analyzes the data and associated metadata (e.g., metadata associated with physical objects and/or virtual world collaborative environment) to identify the context of the of the virtual collaboration. Component 150 may identify the purpose of the virtual world collaborative environment. In various embodiments, component 150 analyzes the virtual world collaborative environment to collect and identify the characteristics of the virtual world collaborative environment, wherein the analysis comprises examining the virtual environment, the presence of avatars or virtual objects, and the activities taking place within the environment. The characters may comprise, but are not limited to features, subject/topic of the virtual world collaborative environment, time of day, participants, host system, interactions, and agenda of the interactions.

In various embodiments, component 150 analyzes the interactions and behaviors of the users within the virtual world collaborative environment, wherein the analyzing of the interactions comprises, but is not limited to, studying user movements, communication patterns, and engagement with virtual objects or other participants. In various embodiments, component 150 searches and identifies cues or indicators within the virtual world collaborative environment that provide context clues. The cues may comprise visual elements, audio cues, textual information, and/or any other contextual information embedded in the environment. Component 150 may utilize machine learning and artificial intelligence techniques to analyze and process the gathered data, which may comprise applying natural language processing, computer vision, and/or data mining algorithms to identify patterns, correlations, and context-related information.

In block 306, component 150 identifies defects in the physical objects based on the context. In the depicted embodiment, component 150 identifies defects in the one or more physical objects and/or predetermined area of the physical space. In various embodiments, based on the metadata analysis and contextual considerations, component 150 applies selection criteria to determine which physical objects should be shown in the virtual world collaborative environment. The criteria may include, but is not limited to, object importance, visual aesthetics, functional relevance, or user-defined preferences. Component 150 may identify the contextual relevancy of the one or more physical objects in relation to the virtual world collaboration environment. In various embodiments, component 150 identifies the contextual relevancy of the one or more physical objects to be displayed as a digital object in the virtual world collaborative environment, along with the quality of the one or more physical objects (i.e., identifying defects in physical objects 165). In various embodiments, component 150 receives and/or retrieves a predefined context and purpose of the virtual world collaborative environment. Component 150 may identify the goals, activities, and theme of the virtual world collaborative environment to establish the criteria for the selection of the one or more physical objects and identify defects in the one or more physical objects.

In block 308, component 150 creates a visualization of the physical object to be displayed in the virtual world collaboration environment. In various embodiments, component 150 utilizes a virtual reality system and IoT sensors to create a visualization of one or more physical objects in a predetermined area of a physical space. In various embodiments, component 150, via a VR system, scans the selected physical objects or predetermined area and utilizes the scan to create a 3D virtual world model rendering of the predetermined area of a physical space, and enable participants to interact with and perceive the one or more physical objects and the predetermined area virtually.

In block 310, component 150 determines if the defect or physical object fits within the context of the virtual world collaboration environment. In various embodiments, component 150 determines whether the one or more physical objects and/or defects of the one or more physical objects fits within the identified context of the virtual world collaboration environment. In the depicted embodiment, if component 150 determines that the defects and/or physical objects fits within the identified context of the virtual world collaboration environment (Yes Block) then component 150 advances to step 412. In the depicted embodiment, if component 150 determines that the defects and/or physical objects do not fit within the identified context of the virtual world collaboration environment (No Block) then component 150 advances to step 414.

In block 312, component 150 outputs the visualization of the physical object with the defect. In various embodiments, component 150 outputs the visualization of the physical object with the defect to a secondary user. Component 150 may mitigate confusion by enabling participants to visualize the actual states of the physical objects, distinguishing between the physical and corrected surroundings. For example, creating two different virtual visualizations of the physical object, wherein the first virtual visualization is an exact virtual replication of the physical object including the identified defects and the second virtual visualization is a virtual representation of the physical object without the defects, and wherein the first virtual visualization is displayed only to a first user and the second visualization is displayed to one or more second users. Component 150 may ensure a visually distinct representation of virtual objects from the corresponding physical counterpart in the virtual world collaborative environment.

In block 314, component 150 modifies the visualization of the physical object to remove the defect. In various embodiments, component 150 utilizes a 3D GAN to modify the visualization of the one or more physical objects to remove the defect and match the identified context of the virtual collaboration environment. In the depicted embodiment, component 150 modifies the visualization of the one or more physical objects based on the identified defects. In various embodiments, component 150 modifies, via a GAN, the visualization of the one or more physical objects in the virtual world collaborative environment. In various embodiments, based on the context of the virtual world collaboration environment, component 150 validates the current state of the one or more physical objects and the deviation from a predetermined quality level for a virtualized physical object. In various embodiments, based on the validation and deviation of quality, component 150 applies a GAN to correct the quality of the physical object in the virtual world collaborative environment by modifying the visualization of the one or more physical objects until a predetermined threshold is met and/or predetermined guidelines or policies are met. In various embodiments, component 150 utilizes a GAN to identify defects in the one or more physical objects and/or predetermined area, wherein component 150 utilizes the GAN to modify the visualization of the one or more physical objects and/or predetermined area of the physical space to match the identified context of virtual world collaboration environment, meet a predetermined threshold, and/or satisfy a predetermined policy. In the depicted embodiment, component 150 generates a modified visualization of the one or more physical objects and/or physical space. In various embodiments, component 150 generates a modified visualization of the one or more physical objects and/or physical space in the virtual world collaboration environment.

In block 316, component 150 outputs the modified visualization to the virtual world collaboration environment. In various embodiments, component 150 outputs, via a VR system, the modified visualization of the one or more physical objects and/or physical space in virtual world collaboration environment. In various embodiments, the visualization is generated in such a manner that it enables user interaction. Component 150 may enable user interaction with the visualization including the modification and context of the virtual world collaboration environment through haptic feedback (e.g., touch, feel, and handle). In various embodiments, component 150, via haptic feedback system and sensors, enables a user to interaction with the visualization including the modification and context of the virtual world collaboration environment. Component 150 may receive haptic feedback from the interaction between the user and the visualization of the physical object. In various embodiments, component 150 generates a list of identified defects (e.g., potential modifications) and outputs a list to the user to selectively choose which modifications to apply to the visualization. In various embodiments, responsive to receiving user feedback (e.g., haptic feedback and/or user selection) component 150 applies the selected and instructed modifications.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures (i.e., FIG.) illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
identifying a context associated with a current state of a virtual environment;
determining a physical object that is being rendered as a virtual display in the virtual environment based on the context; and
rendering a virtual object representing the physical object according to the context using a generative model, wherein the virtual object is rendered visually distinct from the physical object being represented.

2. The computer-implemented method of claim 1 further comprising:
identifying modifications to be applied to the virtual display representing the physical object within the virtual environment based on the context of the virtual environment; and
executing the modifications, through a three-dimensional generative adversarial network, to the virtual display representing the physical object within the virtual environment based on the context of the virtual environment, wherein the virtual environment is a virtual world collaborative environment.

3. The computer-implemented method of claim 2, wherein identifying the modifications further comprises:
identifies defects in the physical object and a predetermined area of a physical space; and
applying a selection criterion to determine that the physical object should be shown in the virtual environment based on a metadata analysis and contextual considerations.

4. The computer-implemented method of claim 1 further comprising:
responsive to identifying the physical object from a physical environment is going to be displayed within the context of the virtual environment, retrieving predetermined commands that instruct a virtual environment construction engine to modify the visual of the physical object in accordance with one or more requirements of one or more predetermined policies and the context of the virtual environment.

5. The computer-implemented method of claim 1 further comprising:
identifying metadata by analyzing data associated with a predetermined area in a physical space and the context of the virtual environment;
associating the metadata to the physical object in the predetermined area in the physical space; and
identifying one or more adaptations to be made to a visual appearance of the virtual rendering of the physical objects in the virtual environment based on the metadata and the context of virtual environment.

6. The computer-implemented method of claim 5, further comprising:
assigning one or more unique identifiers or tags to the physical object to establish a link between the physical object and the associated metadata.

7. The computer-implemented method of claim 1, wherein identifying the context of the virtual environment, further comprises:
analyzing factors associated with the context of the virtual environment, wherein the factors comprise: a purpose the virtual environment, participants of the virtual environment, location associated with the virtual environment, specific requirements associated with the virtual environment, visual coherence, relevance of the physical object and an identified defect, and a desired collaborative experience.

8. A computer system comprising:
one or more computer processors;
one or more computer readable storage devices;
program instructions to identify a context associated with a current state of a virtual environment;
program instructions to determine a physical object that is being rendered as a virtual display in the virtual environment based on the context; and
program instructions to render a virtual object representing the physical object according to the context using a generative model, wherein the virtual object is rendered visually distinct from the physical object being represented.

9. The computer system of claim 8, further comprising:
program instructions to identify modifications to be applied to the virtual display representing the physical object within the virtual environment based on the context of the virtual environment; and
program instructions to execute the modifications, through a three-dimensional generative adversarial network, to the virtual display representing the physical object within the virtual environment based on the context of the virtual environment, wherein the virtual environment is a virtual world collaborative environment.

10. The computer system of claim 9, wherein identifying the modifications further comprises:
program instructions to identify defects in the physical object and a predetermined area of a physical space; and
program instructions to apply a selection criterion to determine that the physical object should be shown in the virtual environment based on a metadata analysis and contextual considerations.

11. The computer system of claim 8, further comprising:
responsive to identifying the physical object from a physical environment is going to be displayed within the context of the virtual environment, program instructions to retrieve predetermined commands that instruct a virtual environment construction engine to modify the visual of the physical object in accordance with one or more requirements of one or more predetermined policies and the context of the virtual environment.

12. The computer system of claim 8, further comprising:
program instructions to identify metadata by analyzing data associated with a predetermined area in a physical space and the context of the virtual environment;
program instructions to associate the metadata to the physical object in the predetermined area in the physical space; and
program instructions to identify one or more adaptations to be made to a visual appearance of the virtual rendering of the physical objects in the virtual environment based on the metadata and the context of virtual environment.

13. The computer system of claim 12, further comprising:
program instructions to assign one or more unique identifiers or tags to the physical object to establish a link between the physical object and the associated metadata.

14. The computer system of claim 8, wherein identifying the context of the virtual environment, further comprises:
program instructions to analyze factors associated with the context of the virtual environment, wherein the factors comprise: a purpose the virtual environment, participants of the virtual environment, location associated with the virtual environment, specific requirements associated with the virtual environment, visual coherence, relevance of the physical object and an identified defect, and a desired collaborative experience.

15. A computer program product comprising:
one or more computer readable storage devices and program instructions stored on the one or more computer readable storage devices, the stored program instructions comprising:
program instructions to identify a context associated with a current state of a virtual environment;
program instructions to determine a physical object that is being rendered as a virtual display in the virtual environment based on the context; and
program instructions to render a virtual object representing the physical object according to the context using a generative model, wherein the virtual object is rendered visually distinct from the physical object being represented.

16. The computer program product of claim 15, further comprising:
program instructions to identify modifications to be applied to the virtual display representing the physical object within the virtual environment based on the context of the virtual environment; and
program instructions to execute the modifications, through a three-dimensional generative adversarial network, to the virtual display representing the physical object within the virtual environment based on the context of the virtual environment, wherein the virtual environment is a virtual world collaborative environment.

17. The computer program product of claim 16, wherein identifying the modifications further comprises:
program instructions to identify defects in the physical object and a predetermined area of a physical space; and
program instructions to apply a selection criterion to determine that the physical object should be shown in the virtual environment based on a metadata analysis and contextual considerations.

18. The computer program product of claim 15, further comprising:
responsive to identifying the physical object from a physical environment is going to be displayed within the context of the virtual environment, program instructions to retrieve predetermined commands that instruct a virtual environment construction engine to modify the visual of the physical object in accordance with one or more requirements of one or more predetermined policies and the context of the virtual environment.

19. The computer program product of claim 15, further comprising:
program instructions to identify metadata by analyzing data associated with a predetermined area in a physical space and the context of the virtual environment;
program instructions to associate the metadata to the physical object in the predetermined area in the physical space;
program instructions to identify one or more adaptations to be made to a visual appearance of the virtual rendering of the physical objects in the virtual environment based on the metadata and the context of virtual environment; and
program instructions to assign one or more unique identifiers or tags to the physical object to establish a link between the physical object and the associated metadata.

20. The computer program product of claim 15, wherein identifying the context of the virtual environment, further comprises:
program instructions to analyze factors associated with the context of the virtual environment, wherein the factors comprise: a purpose the virtual environment, participants of the virtual environment, location associated with the virtual environment, specific requirements associated with the virtual environment, visual coherence, relevance of the physical object and an identified defect, and a desired collaborative experience.
